(19) United States
(12) Patent Application Publication
(10) Pub. No.: US 2026/0203587 A1
(43) Pub. Date: Jul. 16, 2026

(54) DISCOVERING LATENT FUNCTIONS USING A DIGITAL FOOTPRINT

(71) Applicant: INTERNATIONAL BUSINESS MACHINES CORPORATION, Armonk, NY (US)

(72) Inventors: Irving A. Duran, Dubuque, IA (US); Bernard Freund, Victoria (CA); Carolina Garcia Delgado, Zapopan (MX); Jason Malinowski, Pittstown, NJ (US)

(21) Appl. No.: 19/020,754

(22) Filed: Jan. 14, 2025

(51) Int. Cl. G06N 3/088

(52) U.S. Cl. CPC G06N 3/088

(57) ABSTRACT

Resource role discovery and alignment includes searching, with a search engine, one or more enterprise data sources for digital data pertaining to an enterprise resource. A resource-specific digital footprint is generated based on the digital data. Based on the digital footprint, a prediction distance between the digital footprint and a predetermined resource taxonomy is generated by a multipart machine learning model. The prediction distance is transmitted to a networked resource control platform. A resource alignment recommendation is transmitted to the networked resource control platform in response to the prediction distance exceeding a predetermined threshold. The resource alignment recommendation recommends revising a resource designation previously assigned to the enterprise resource.

### BACKGROUND

This disclosure relates to artificial intelligence (AI), and, more particularly, to topic models for mining textual content for resource-related role discovery, alignment, and position recommendation using natural language processing (NLP).

Mining text is an aspect of NLP that applies unsupervised learning to large sets of textual data. Through unsupervised learning, a machine learning model—specifically, a topic model—learns to identify words or phrases within the textual data and to cluster the words or phrases into a discrete number of topics. The learning is unsupervised in that the training of the topic model does not require labeled examples nor any indication of topic specificity. The topic model itself uncovers latent topics, or themes, characterizing the textual material.

### SUMMARY

In one or more embodiments, a method of resource discovery and alignment includes searching, with a search engine, one or more enterprise data sources for digital data pertaining to an enterprise resource. A resource-specific digital footprint is generated based on the digital data. Based on the digital footprint, a prediction distance between the digital footprint and a predetermined resource taxonomy is generated by a multipart machine learning model. The prediction distance is transmitted to a networked resource control platform. A resource alignment recommendation is transmitted to the networked resource control platform in response to the prediction distance exceeding a predetermined threshold. The resource alignment recommendation recommends revising a resource designation previously assigned to the enterprise resource.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of a computing environment that is capable of implementing a resource role discovery framework.

FIG. 2 illustrates an example architecture of the resource role discovery framework.

FIG. 3 illustrates an example method of operation of the resource role discovery framework of FIG. 2.

FIG. 4 illustrates an example graphical user interface (GUI) screen display generated by the resource role discovery framework described with reference to FIGS. 2 and 3.

FIG. 5 illustrates another example GUI screen display generated by the resource role discovery framework described with reference to FIGS. 2 and 3.

FIG. 6 illustrates certain operative aspects of the resource role discovery framework implemented in FIGS. 2 and 3 in the context of an enterprise employee.

### DETAILED DESCRIPTION

While this disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to AI, and, more particularly, to topic models for mining textual content for resource-related role discovery, alignment, and position recommendation content using NLP. In accordance with the inventive arrangements described herein, methods, systems, and computer program products are provided that are capable of extracting textual content from a digital footprint, and from mining the textual content, discovering the latent functions or tasks performed with or by a resource within an enterprise.

A large enterprise or organization may perform many processes and operations. Such an enterprise or organization typically uses many and varied resources, including facilities, equipment, computer hardware and software, assorted machinery, and the like. Not infrequently, the same resource may be utilized at different times for performing different tasks. Notwithstanding an organizational chart or enterprise's designation for a resource, actual activities undertaken or tasks performed with or by an enterprise resource may not align with the resource's assigned designation. For example, one such resource is the enterprise or organization's personnel. The same individual at different times may perform different tasks, assuming multiple roles within the enterprise or organization at various times. At least some of the different roles may not align with a resource title or designated role of the individual. Especially problematic, is drift in which roles of a resource—whether inanimate or human—change as the enterprise or organization evolves over time.

“Drift,” as defined herein, means a time-based evolution in which an enterprise resource (e.g. an employee) initially performs tasks closely aligned with an enterprise-designated role, but over time (e.g., months or years), the nature of these tasks gradually changes to the point where the functions or tasks being performed by the resource no longer adequately align with the enterprise designation. This phenomenon could have different causes. For example, with respect to an employee, drift may be caused by growth in the employee's skills, changing priorities in the organization, introduction of automation, rebalance of work within a department, or another factor. More generally, as the environment in which the enterprise operates changes, one or more roles performed by the enterprise's employee are likely to evolve commensurately. Constant monitoring of the various roles is inefficient is not humanly impossible. The problem is that, at best, it is costly to sufficiently monitor resource roles to detect drift and, at worst, it is humanly impossible to discern the drift as a resource's roles evolve. In one sense, a resource's role(s) is a latent or hidden variable - present but not observable.

In one aspect, the inventive arrangements provide a system that electronically searches networked data sources of an enterprise for data pertaining to a specific enterprise resource. A resource-specific digital footprint is electronically created from the data. Textual context is extracted from the resource-specific digital footprint. The textual content is preprocessed and vectorized for input to a multipart machine learning model. The multipart machine learning model, based on the vectorial representation, generates a prediction distance between the digital footprint and a predetermined resource taxonomy.

The multipart machine learning model, in certain embodiments, is a Hierarchical Optimal Topic Transport (HOTT) model. The HOTT model combines hierarchical latent structures from a selected topic model (e.g., latent Dirichlet allocation) with the geometry of word embeddings and optimal transport (OT), which aggregates different but related datasets through alignment. OT transforms a source dataset to match a target dataset using the Wasserstein distance as a divergence measure under alignment constraints. Combining language information from word embeddings with corpus-specific, semantically meaningful topic distributions from a topic model, the HOTT model generates prediction distances between digital footprints and a predetermined resource taxonomy, the distances providing a metric to measure how closely the footprint aligns with the taxonomy.

Another aspect of the inventive arrangements is the generation of recommendations. The recommendation may be transmitted to a resource controller platform. The recommendation transmitted may indicate that, based on a comparison of prediction distances, a resource should be redesignated according to the predetermined resource taxonomy. The aim of the redesignation is to align the resource with the resource taxonomy by matching the resource to a resource taxonomy designation whose roles align most closely with the machine-discovered roles the resource performs.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

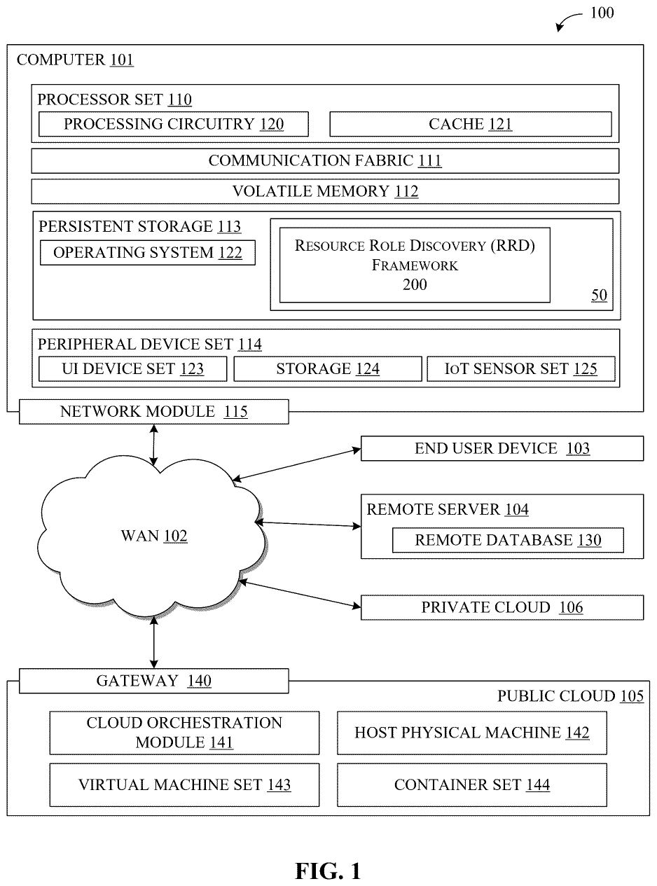

Referring to FIG. 1, computing environment 100 contains an example of an environment for the execution of at least some of the computer code illustrated at block 50 that is involved in performing the inventive methods disclosed herein. The inventive methods performed with the computer code of block 50 can include implementing resource role discovery (RRD) framework 200.

RRD framework 200, implements a multipart machine learning model that is capable of discovering different roles performed by resources utilized by an enterprise. The same resource may perform multiple roles. A human resource (employee), for example, at different times may perform different tasks, engage in different activities, make distinct contributions, and the like. Implementing the multipart machine learning model, RRD framework 200 discovers the roles performed by the resource based on a digital footprint pertaining to the resource. The digital footprint of the human employee, for example, may comprise emails, text exchanges, communications on collaborative enterprise sites, and calendar appointments involving the employee. The multipart machine learning model implemented by RRD framework 200 is capable of detecting a misalignment between a resource designation assigned to the resource and the roles performed by the resource. The resource designation is made in accordance with a predefined resource taxonomy that defines the roles (e.g., tasks, activities) that the enterprise anticipates the resource performing. Implementing the multipart machine learning model, RRD framework 200 is capable of detecting a misalignment between discovered roles actually performed by the resource and those roles associated with the resource designation assigned to the resource. RRD framework 200 is further capable of providing a recommendation to change a previously assigned resource designation in response to the misalignment. The recommendation identifies the resource designation that more closely aligns with the roles actually performed by the resource.

In addition to block 50, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 50, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 50 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 50 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Yet another aspect of the inventive arrangements is presentment in a graphical user face (GUI) of a ranked list of prediction distances. The smaller the prediction distance, the more closely aligned the roles in fact performed by the resource are to those of a resource taxonomy designation.

Still another aspect is the generation of a GUI presentation that visually compares the discovered roles of a resource with those corresponding to different resource taxonomy designations. The GUI may show vectorial representations of the discovered roles and roles designated according to the resource taxonomy, the representations shown as vectors or points within a multi-dimensional vector space (e.g., a two- or a three-dimensional vector space). Using a technique such as t-distributed stochastic neighbor embedding (t-SNE), for example, roles represented by higher-order multi-dimensional vectorial representations may be displayed within the GUI as clusters within a multi-dimensional vector space comprising a two- or three-dimensional vector space.

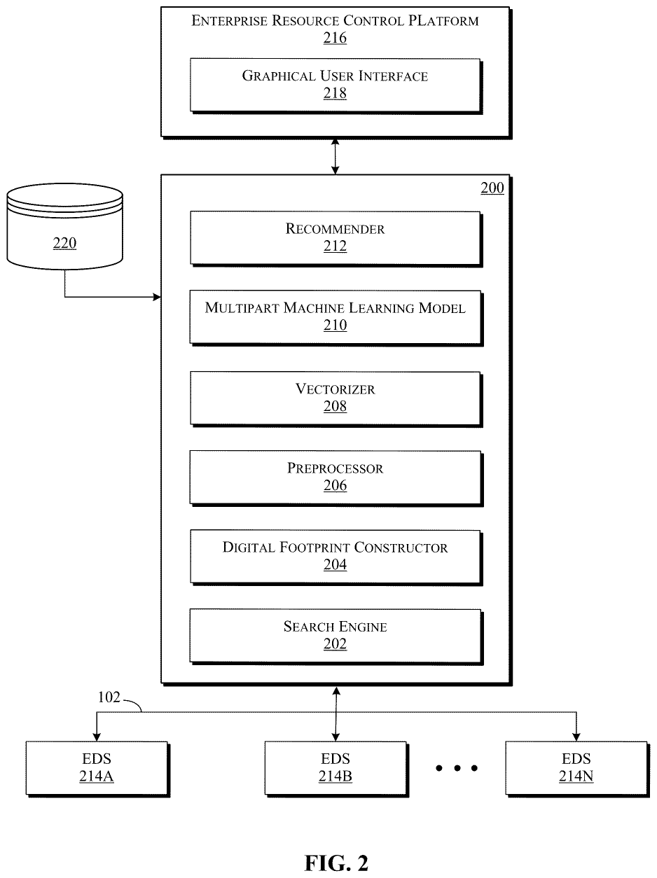

FIG. 2 illustrates an example architecture of RRD framework 200. In the example architecture of FIG. 2, RRD framework 200 illustratively includes search engine 202, digital footprint constructor 204, preprocessor 206, vectorizer 208, multipart machine learning model 210, and recommender 212. RRD framework 200, in certain embodiments, may be implemented with software executable on the hardware of computer 101 operating in computing environment 100.

Implemented in computer 101, RRD framework 200 may utilize the collection of computer software, hardware, and firmware of network module 115 to communicate with other computers through WAN 102. Utilizing network module 115, RRD framework 200 may communicate with enterprise data sources (EDSs) 214a and 214b through 214n, where n is any positive integer. Computer 101 and EDS(s) 214a-214n may be part of an enterprise network that serves as an infrastructure that communicatively couples multiple devices such as end user device 103 and remote server 104 of an organization. The enterprise network may include resource control platform 216 running on or communicatively coupled via WAN 102 with computer 101. Thus, in various embodiments, RRD framework 200 may be integrated in, or communicate via a network, with enterprise resource control platform 216. In certain embodiments, enterprise resource control platform 216 may include UI device set 123 having a display screen on which GUI 218 is displayed. RRD framework 200 additionally communicates with database 220, which electronically stores a predefined resource taxonomy. Database 220, in certain embodiments, may be stored in computer 101 or in remote server 104 along with or as part of remote database 130.

Operatively, RRD framework 200 discovers from digital footprints generated from communications within the enterprise the different roles that enterprise resources perform. As used herein, “role” means any activity, task performed, or contribution made by the resource on behalf of the enterprise. Typically, a resource performs more than one role. The enterprise, depending on the type and extent of the different roles, may assign a resource designation to a resource according to a predefined resource taxonomy. Resource designations, in accordance with the predefined resource taxonomy, are based on one or more roles that the enterprise expects or anticipates a resource to perform. For example, in the context of personnel resources, a resource designation may comprise a job role and/or job title (JR/JT), such as data analyst, system administrator, or the like. Regardless of the organization of the enterprise or resource designations, however, there is a potential misalignment or divergence between the assigned or anticipated roles and ones actually performed by an enterprise resource. This may be especially so with respect to human resources. Roles of an employee can vary widely, and it is often difficult to thoroughly observe or quantify the different roles. To deal with the challenge, RDD framework 200 implements multipart machine learning model 210, which is capable of being trained to discover from a resource's digital footprint the roles performed by a resource. RDD framework 200 is capable of providing a metric (prediction distance, described below) that measures how closely the discovered roles align with the resource designation assigned to the resource in accordance with the predefined taxonomy. RDD framework 200 is also capable of generating a recommendation to correct a significant misalignment when detected.

Multipart machine learning model 210, in certain embodiments, implements the HOTT model to calculate prediction distances between digital footprints and a predefined resource taxonomy. HOTT model combines corpus-specific, semantically meaningful topic distributions of the topic model (e.g., latent Dirichlet allocation) with language information from word embeddings that map words to a vector space in which similar-meaning words are close to one another. In modeling the digital footprints as distributions over resource roles, which are themselves modeled as distributions over words, HOTT generates prediction distances between the footprints and the predefined resource taxonomy. A probability distribution over resource roles assigns probabilities to each role, the probabilities indicating for each of a fixed number of roles the likelihood of a role's appearing in a digital footprint. A probability distribution over words assigns probabilities to each word, the probabilities indicating for each word of a fixed vocabulary the likelihood the word describes a given role. Thus, based on the words within the textual content of the digital footprint, the topic model predicts the likelihood of roles being found within the footprint. For example, if the number of roles were only three (the number is a fixed hyperparameter)—say, data analyst, system programmer, and meteorologist—the topic model may determine, that 90% of the footprint pertains to the role of a data analyst, 9% to the role of a system programmer, and 1% to the role of a meteorologist.

In certain embodiments, words may be weighted in accordance with roles corresponding to the enterprise's predefined resource taxonomy. That is, words already known to be associated with roles defined by the resource taxonomy may be weighted more heavily than other words within a corpus of digital footprints. Words such as “regression,” “logit,” and “neural network,” for example, may be accorded relatively higher weight if is known that a role defined by the resource taxonomy is that of data scientist and that the words are strongly correlated with work done, tasks performed, and the like by a data scientist. Such customized weighting based on prior, specific knowledge may enhance the performance of the topic model incorporated in the HOTT model.

The HOTT model incorporates hierarchical latent structures from the topic model (e.g., latent Dirichlet allocation) with the vector-space geometry of word embedding and uses OT to compute prediction distances between a resource's digital footprint and resource designations defined by the resource taxonomy. The resource's digital footprint is analogous to a document, and roles performed by the resource are analogous to topics within the document. Trained using unsupervised learning, the topic model generates from a given corpus of role descriptions (documents) (i) a topic distribution over words and/or phrases within the digital footprint and (ii) a document distribution over the roles (topics). Using the role (topic) distributions with information from word embeddings, multipart machine learning model 210 generates the prediction distances between a digital footprint and the taxonomy. The greater a prediction distance, the more the roles the resource performs, as identified from the digital footprint, differ from the roles designated by the taxonomy.

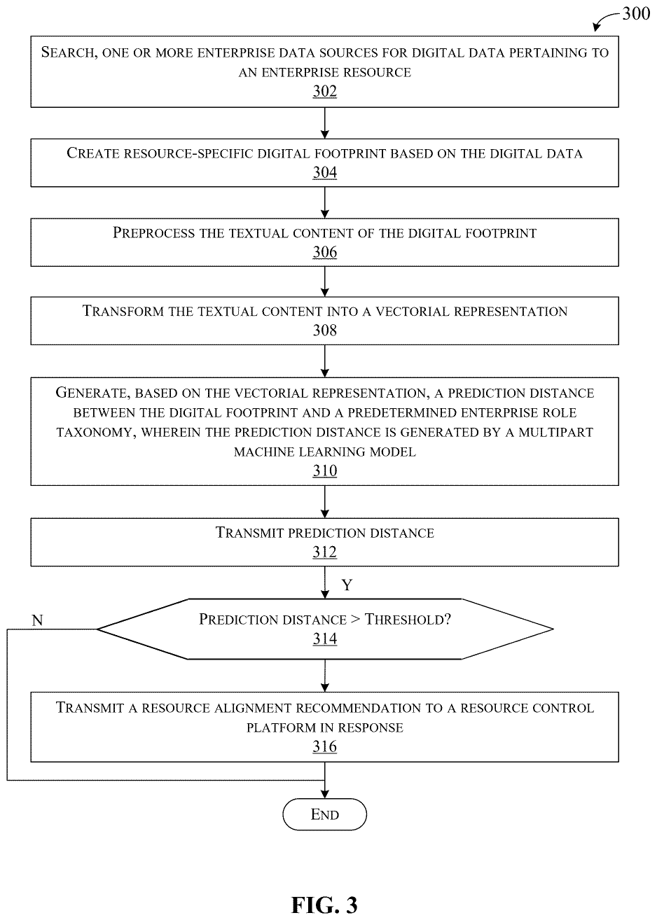

FIG. 3 illustrates an example method 300 of operation of RDD framework 200 of FIG. 2. Referring to FIGS. 2 and 3 collectively, in block 302, search engine 202 searches EDS(s) 214a-214n. EDS(s) 214a-214n may electronically store digital data generated by a resource (e.g., enterprise employee) or about a resource (e.g., facility, equipment, intangible property). One or more EDS(s) 214a-214n may comprise remote server 104, which includes remote database 130. Search engine 202 may communicate with EDS(s) 214a-214n via WAN 102. Search engine 202 may identify documents based on a resource indicator (e.g., equipment or employee ID, facility address) or name (e.g., employee name). With respect to enterprise employees specifically, EDS(s) 214a-214n may electronically store digital data generated by an enterprise project management or collaboration tool, for example, pertaining to work and/or activities involving the employee. The digital data may include enterprise email exchanges, text exchanges, communications on collaborative enterprise sites, and calendar appointments involving the employee. The digital data may include electronically stored reports generated by the employee or describing work and activities performed by and/or involving the employee.

It is likely that a significant amount of the digital data electronically stored by EDS(s) 214a-214n does not explicitly describe the roles performed over time by the resource - that is, the explicit designation is a latent or hidden variable. The digital data likely only describes aspects of the roles. For example, in the context of an enterprise employee, the digital data may describe the activities performed, contributions made, or other aspects pertaining to the employe's work, but without explicitly characterizing or categorizing the roles the employee performed. It would be very difficult if not humanly impossible for one to discern the employee's roles merely from the words of description stored in EDS(s) 214a-214n as distributed digital data.

At block 304, digital footprint constructor 204 compiles digital data collected from EDS(s) 214a-214n by search engine 202, creating from the digital data a resource-specific digital footprint. As described above, the digital footprint is analogous to a document that may cover multiple topics, depending on the nature of the document. Likewise, the digital footprint may pertain to multiple roles performed at various times by the specific resource to which the digital footprint pertains.

At block 306, preprocessor 206 preprocesses the textual content of the digital footprint using natural language processing. Preprocessor 206 tokenizes the words comprising the textual content and removes stop words (e.g., pronouns, articles, prepositions, and conjunctions) that provide little or no substantive information. Preprocessor 206 may also perform stemming on the textual content to reduce each word to its root form or base. Preprocessor 206, alternatively, may lemmatize the textual content, which also reduces the words to their root forms but does so considering each word's context and part of speech to determine the true root of each.

At block 308, vectorizer 208 transforms the textual content into a vectorial representation. The vectorial representation may be a vector or n-tuple whose n elements are term (word) frequencies or occurrences of distinct words in the textual content extracted from the digital footprint. In embodiments in which the topic model of multipart machine learning model 210 is the latent Dirichlet allocation model, the textual content may be transformed by vectorizer 208 into a term-document matrix. In the present context, terms correspond to words comprising the textual content, and the document corresponds to the resource-specific digital footprint. The matrix is needed to provide the latent Dirichlet allocation model with an input analyzable by the model. Based on the vectorized input, the latent Dirichlet allocation model, once trained, is capable of analyzing the textual content and determining the underlying topics—that is, roles performed by the resource specific to the resource-specific digital footprint.

At block 310, based on the vectorial representation, multipart machine learning model 210 generates a prediction distance between the digital footprint and a predetermined enterprise resource taxonomy. Multipart machine learning model 210 incorporates the trained topic model that is capable of identifying from the vectorized textual content of the resource-specific footprint, the roles (or in some arrangements the top n roles) performed by the resource. In certain embodiments, as already noted, the topic model incorporated in multipart machine learning model 210 is the latent Dirichlet allocation model. The latent Dirichlet allocation model is able to identify the roles based on words in the textual content in the same manner that the model identifies topics from words in a document. With the latent Dirichlet allocation model, a document-topic distribution provides for each of k topics (a hyperparameter) a probability indicating the likelihood that the topic is present in a document. Additionally, with the latent Dirichlet allocation model, a topic-word distribution provides for each word of a fixed vocabulary a probability that the word appears in a topic. The latent Dirichlet allocation model is trained on a dataset of documents by initially assigning words to topics randomly and then updating the document-topic distribution and the topic-word distribution using iterative optimization until the model converges. Implemented with multipart machine learning model 210, the latent Dirichlet allocation model at block 310, once trained, generates a vector for a resource from the resource's footprint. The vector elements indicate the likely contribution each role (or top n roles for an n-element vector) played in the resource's total performance—that is, of all the roles performed by the resource, what is the relative importance of each.

Multipart machine learning model 210 implements the known HOTT model to calculate prediction distances between digital footprints and a predefined resource taxonomy. HOTT model combines the corpus-specific, semantically meaningful topic distributions of the topic model (e.g., latent Dirichlet allocation) with language information from word embeddings that map words to a vector space in which similar-meaning words are close to one another. In modeling the digital footprints as distributions over resource roles, which are themselves modeled as distributions over words, HOTT generates prediction distances between the footprints and the predefined resource taxonomy by using OT to measure prediction distances between the probability distributions.

As described above, a digital footprint includes words associated with multiple roles. For each word and each role, there is a probability that the word is used in the context of a given role (a topic-word distribution), and for each footprint and role there is a probability (footprint-role distribution) corresponding to the prevalence or contribution of a given role within the footprint. In the previous example involving three roles—data analyst, system programmer, and meteorologist—each role was discovered within the footprint, albeit to a different extent, specifically 90%, 9%, and 1%, respectively. For example, the textual content of the footprint may include words associated with each of the aforementioned distinct roles such as regression, neural network, data collection, data processing, code, dew point, depression, and barometric. Such might be the case, for example, if a human resource (employee) was primarily engaged as a data analyst, who at some point during time period in which the digital content comprising the digital footprint was generated provided a data analysis with respect to a meteorological event. The assumption that the human resource is primarily engaged as a data analyst reflects the fact that some of the words (e.g., regression, neural network) are strongly associated with the role of data analyst and occurred in the digital footprint with high frequency. Words or phrases such as code, data collection, and data processing might well apply to both a data analyst and a system programmer, but in the present example, were likely less prevalent than words associated with the role of data analyst.

Similarity between roles discovered in a digital footprint and resource designations in accordance with a predefined resource taxonomy can be quantified by prediction distances. Implementing multipart machine learning model 210 as the HOTT model, the prediction distances are generated using hierarchical optimal transport, in which the distance between two footprints is the Wasserstein distance between their distributions over roles and the ground metric is another Wasserstein distance between roles represented as distribution over word embeddings. To determine whether the roles performed by a resource are aligned with the roles of a resource designation in accordance with the predefined resource taxonomy, a prediction distance between the footprint and resource designation is generated. In the previous example, assuming only three roles within the enterprise, the resource designation of a data analyst might correspond, respectively, to 95%, 5%, and 0%. The prediction distance is generated by defining the probability distributions (e.g., histograms, probability density functions, or empirical distributions), formulating transforming the probabilities associated with the footprint into those associated with the resource designation as a transportation plan having multi-step transport costs, using mathematical optimization to minimize the costs, and summing the costs to generate the prediction distance.

At block 312, a prediction distance generated by multipart machine learning model 210 is transmitted to resource control platform 216. If, at block 314, the prediction distance exceeds a predetermined threshold, then recommender 212 may also transmit an alignment recommendation to resource control platform 216 in block 316. If resource control platform 216 is communicatively coupled with, but separately located from, RRD framework 200, then the alignment recommendation may be transmitted via a wired or wireless connection. For example, if resource control platform 216 is implemented in remote server 104, then alignment recommendation can be conveyed via WAN 102. The alignment recommendation, in certain embodiments, recommends revising the previously assigned resource designation assigned to a resource. The recommendation may be to assign a different resource designation of the predefined taxonomy to the resource. The different resource designation is one that, based on roles associated with it, has a smaller, or smallest, prediction distance to the resource's digital footprint.

Accordingly, multipart machine learning model 210 implemented as the HOTT model may be trained to discover from the vectorial representation of textual content extracted from a digital footprint each role performed by an enterprise resource and the contribution that each role makes to an overall performance of the enterprise resource. That is, the HOTT model implemented by multipart machine learning model 210 identifies the resource's roles (or top n roles) in terms of specific activities or work performed by the resource and the relative importance of each overall. The relative importance, in certain arrangements, may be uniformly measured by the amount of time the resource spends performing the identified activity or work. Digital footprints may cover a predetermined period of time (e.g., six months, year), and may be created at periodic intervals corresponding to the predetermined period of time (e.g., annually).

The prediction distances thus may quantify the relative strength of association between the enterprise resource and resource designation defined by the resource taxonomy. In certain embodiments, the relative strength of association is measured based on multiple prediction distances measured between roles performed by the enterprise resource and roles corresponding to the resource designation. RDD framework 200 generates a ranked listing of the multiple predictions. The smaller the prediction distance between the footprint of a resource and a resource designation according to a predefined taxonomy, the greater the alignment of the resource with the resource designation.

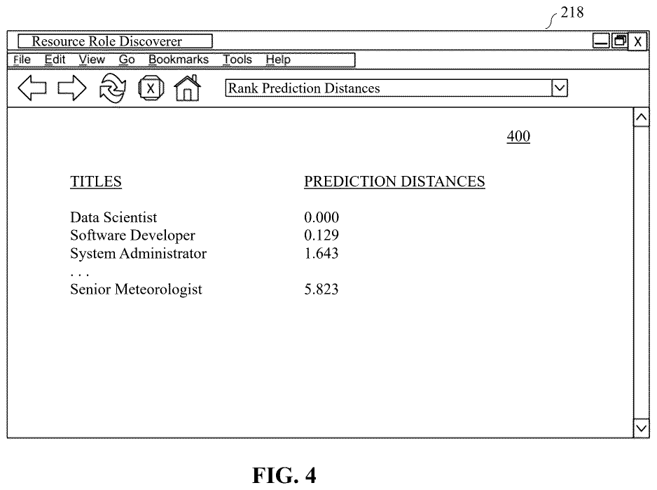

FIG. 4 illustrates ranked listing 400 generated by RRD framework 200 for presentation in GUI 218 of resource control platform 216. Illustratively, the enterprise resource is a personnel resource and example resource designations include Data Scientist, Software Developer, and Senior Meteorologist. The zero prediction between the Data Scientist resource designation and the footprint of an enterprise employee (the resource) as generated by RRD framework 200 indicates a perfect alignment of the work or activities performed by the enterprise employee and the work or activities (the roles) performed by a Data Scientist. The roles performed by the enterprise employee, based on the textual content extracted from the footprint, also evince close alignment, as well, with Software Developer, as indicated by the relatively small prediction distance. The relatively large prediction distance with respect to Senior Meteorologist indicates that the roles performed by the enterprise employee are not closely aligned with those of an enterprise meteorologist.

RRD framework 200 is capable of outputting the data in various formats (e.g., a web page). Certain elements may be hyperlinked to the underlying data, such as an employee's job title and description in an enterprise organizational chart or another resource designation in accordance with the enterprise's resource taxonomy. RRD framework 200 may be implemented as an interactive system such that by selecting a role identified with a resource, the user is linked to items of the digital footprint that contributed (or most significantly contributed) to the result generated by multipart machine learning model, selecting other roles will link to other items of the digital footprint correlated with the selected roles.

In another interactive embodiment, RRD framework 200 may be configured to determine based on prediction distances, how many enterprise resources are performing certain roles. For example, the user may request an output identifying all resources whose footprints are within a certain prediction distance of a user-selected resource designation in accordance with the resource taxonomy. This enables the user to ascertain how many and which resources are primarily engaged in roles associated with a specific resource designation, regardless of how the resources are officially designated according to an organization chart. For example, with respect to human resources, the digital footprint of one or more employees may be closely aligned with the roles performed by a data analyst even though some or all of the employees may have official job titles as something other than data analyst. The identification of which roles which resources are performing based on the resources' footprints provides an insight that the enterprise would not likely be able to obtain otherwise. Moreover, identification of roles from footprints reveals disparities between the actual roles (e.g., jobs, work, tasks) performed by the enterprise's resources and the enterprise's organizational chart.

Implemented as an interactive system, RRD framework 200 may generate the ranked listing of the multiple prediction distances for presentation with GUI 218 and provide hyperlinks within the GUI that enable a user to hyperlink descriptions associated with resource designations corresponding to each prediction distance listed. The descriptions may describe roles performed by a resource assigned to each of the different resource designations.

In certain embodiments, the processes performed by RRD framework 200 are performed in response to a predetermined triggering event. The predetermined triggering event may be a periodic passage of time. In other embodiments, the triggering event may be identifying misalignment between roles performed by a resource and the resource designation assigned. The triggering event may be the prediction distance between the resource's footprint and the resource designation according to the predefined resource taxonomy.

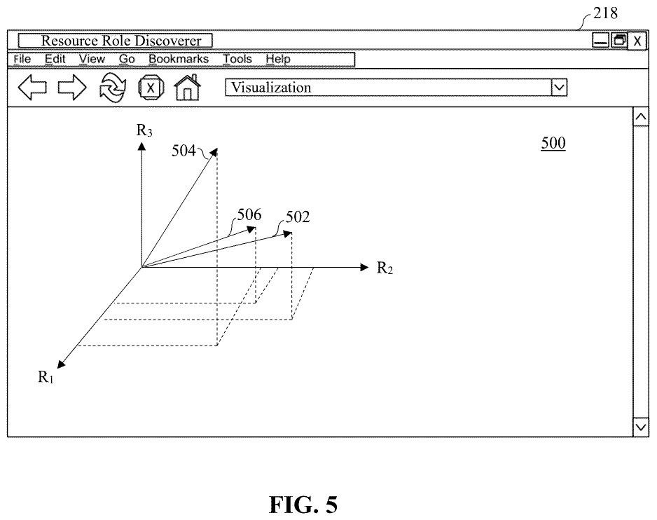

FIG. 5 illustrates example visualization 500 generated by RRD framework 200 for presentation in GUI 218 of resource control platform 216. Visualization 500 provides a multi-dimensional vector space in which the textual content extracted from the footprint of a resource is presented as vector 502 generated by multipart machine learning model 210. The elements of vector 502 indicate respective roles (three) performed by the resource. Illustratively, roles defined for two resource designations in accordance with a predefined taxonomy are expressed as vectors 504 and 506. An easily made visual comparison reveals that the roles of the resource represented by vector 502 are more closely aligned with those of resource designation 506. A quantitative comparison, in various embodiments, may be generated by RRD framework 200 computing a distance metric (e.g., Euclidean) between the respective vectors.

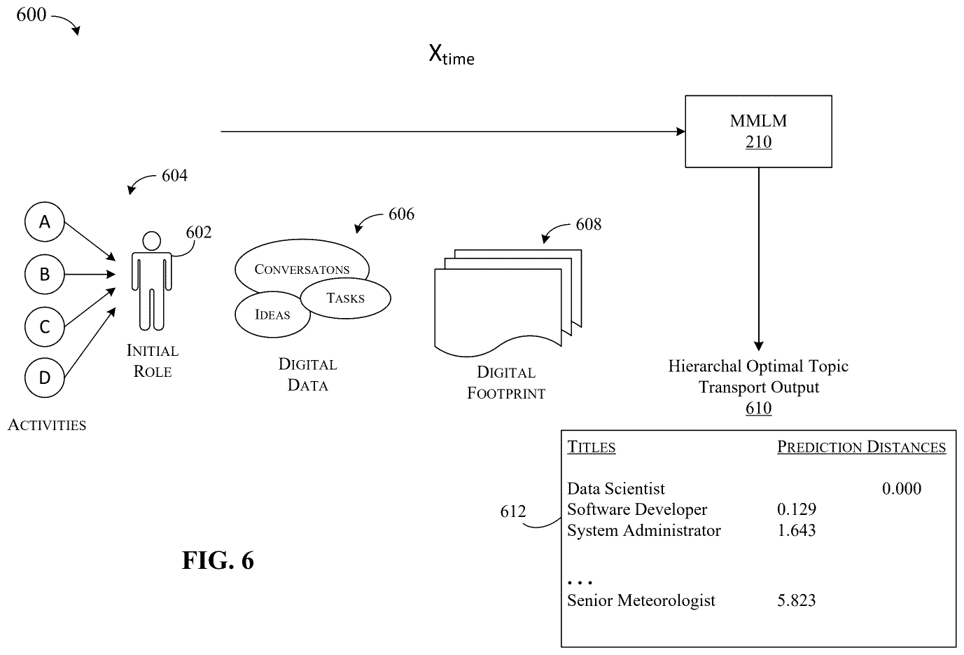

FIG. 6 illustrates certain operative aspects of RRD framework 200 in which the resource for which a digital footprint is generated is an enterprise employee operating within environment 600. Illustratively, enterprise employee 602 in an initial role performs activities 604. Regardless of the intended organizational structure of the enterprise, resources may not be used in alignment with a predefined resource taxonomy. This may be due to various factors, such as the evolving nature of the enterprise or other factors described above. So, too, the work performed by and/or activities engaged in by enterprise employee 602 may evolve over time (denoted as Xₜᵢₘₑ). Digital data 606 captures ideas contributed, conversations involving, tasks performed by, and other activities of enterprise employee 602. Digital data 606, however, does not explicitly identify or quantify the extent of the roles performed by enterprise employee 602. Nonetheless, digital footprint 608 can be constructed by digital footprint constructor 204. Preprocessor multipart machine learning model 210, implementing a HOTT model, generates HOTT output 610, which includes prediction distance between digital footprint 608 and a predefined resource taxonomy initially assigned to enterprise employee 602. Based on the output generated, recommender 212 may generate a recommendation in response to the prediction distance exceeding a predetermined threshold (e.g., 0.10). The recommendation may recommend a new resource designation (e.g., JT) for enterprise employee 602. The new resource designation may be one in which the prediction distance between corresponding roles and digital footprint 606 is less than the same or an alternate threshold. RRD framework 200 may also generate images 612 on GUI 218 of resource control platform 216. Images 612 may provide a visual comparison of vectorial or clustered representations of the resource roles determined from digital footprint 608 and based on the predefined resource taxonomy.

In certain embodiments, the processes performed by RRD framework 200 are performed in response to a predetermined triggering event. The predetermined triggering event may be a periodic passage of time. For example, with respect to enterprise employee 602 of FIG. 6, generation of digital footprint 606 may be performed every six months or once a year given that the employee's roles may evolve in as little as six months to a year. Another triggering event, for example, may be the evolving nature of the enterprise, in which resource roles are likely to evolve as well. RRD framework 200 does not organize or reorganize the resources. Rather, RRD framework 200 is capable of discovering the true roles performed by resources irrespective of an intended organization plan or scheme. Moreover, RRD framework 200 is able to ascertain the true roles from prediction distances with a machine learning model able to infer the roles as latent variables within a digital footprint.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A method, comprising:
searching, with a search engine, one or more enterprise data sources for digital data pertaining to an enterprise resource;
generating, based on the digital data, a resource-specific digital footprint;
generating, based on textual content of the resource-specific digital footprint, a prediction distance between the resource-specific digital footprint and a predetermined resource taxonomy, wherein the prediction distance is generated by a multipart machine learning model;
transmitting the prediction distance to a networked resource control platform; and
transmitting a resource alignment recommendation to the networked resource control platform in response to the prediction distance exceeding a predetermined threshold, wherein the resource alignment recommendation recommends revising a resource designation previously assigned to the enterprise resource.

2. The method of claim 1, wherein the multipart machine learning model is constructed by combining a trained topic model, optimal transport, and word embeddings.

3. The method of claim 2, wherein the multipart machine learning model is trained to discover one or more roles performed by the enterprise resource and a contribution that each role makes to an overall performance of the enterprise resource.

4. The method of claim 3, wherein the multipart machine learning model measures a strength of association between the enterprise resource and multiple resource designations defined by the predetermined resource taxonomy, and wherein the strength of association is measured based on multiple prediction distances between roles performed by the enterprise resource and roles corresponding to the resource designations.

5. The method of claim 4, further comprising:
generating a ranked listing of multiple prediction distances for presentation in a graphical user interface (GUI) provided by the networked resource control platform;
wherein the GUI enables a user to hyperlink to descriptions associated with resource designations corresponding to each of the multiple prediction distances listed, the descriptions describing roles performed by a resource assigned to each of the resource designations.

6. The method of claim 4, further comprising:
generating an image of a multi-dimensional vector space in which a vectorial representation of roles performed by the enterprise resource appears with one or more vectorial representations of roles defined by the predetermined resource taxonomy, wherein the image appears is capable of appearing in a graphical user interface provided by the networked resource control platform.

7. The method of claim 1, further comprising:
performing the searching and generating the prediction distance in response to a predetermined triggering event.

8. A computer system, comprising:
a processor set;
one or more computer-readable storage media; and
program instructions stored on the one or more computer-readable storage media to cause the processor set to perform operations including:
searching, with a search engine, one or more enterprise data sources for digital data pertaining to an enterprise resource;
generating, based on the digital data, a resource-specific digital footprint;
generating, based on textual content of the resource-specific digital footprint, a prediction distance between the resource-specific digital footprint and a predetermined resource taxonomy, wherein the prediction distance is generated by a multipart machine learning model;
transmitting the prediction distance to a networked resource control platform; and
transmitting a resource alignment recommendation to the networked resource control platform in response to the prediction distance exceeding a predetermined threshold, wherein the resource alignment recommendation recommends revising a resource designation previously assigned to the enterprise resource.

9. The computer system of claim 8, wherein the multipart machine learning model is constructed by combining a trained topic model, optimal transport, and word embeddings.

10. The computer system of claim 9, wherein the multipart machine learning model is trained to discover one or more roles performed by the enterprise resource and a contribution that each role makes to an overall performance of the enterprise resource.

11. The computer system of claim 10, wherein the multipart machine learning model measures a strength of association between the enterprise resource and multiple resource designations defined by the predetermined resource taxonomy, and wherein the strength of association is measured based on multiple prediction distances between roles performed by the enterprise resource and roles corresponding to the resource designations.

12. The computer system of claim 11, wherein the operations further comprise:
generating a ranked listing of the multiple prediction distances for presentation in a graphical user interface (GUI) provided by the networked resource control platform;
wherein the GUI enables a user to hyperlink to descriptions associated with resource designations corresponding to each of the multiple prediction distances listed, the descriptions describing roles performed by a resource assigned to each of the resource designations.

13. The computer system of claim 11, wherein the operations further comprise:
generating an image of a multi-dimensional vector space in which a vectorial representation of roles performed by the enterprise resource appears with one or more vectorial representations of roles defined by the predetermined resource taxonomy, wherein the image appears is capable of appearing in a graphical user interface provided by the networked resource control platform.

14. A computer program product comprising:
one or more computer-readable storage media; and
program instructions stored on the one or more computer-readable storage media to perform operations comprising:
searching, with a search engine, one or more enterprise data sources for digital data pertaining to an enterprise resource;
generating, based on the digital data, a resource-specific digital footprint;
generating, based on textual content of the resource-specific digital footprint, a prediction distance between the resource-specific digital footprint and a predetermined resource taxonomy, wherein the prediction distance is generated by a multipart machine learning model;
transmitting the prediction distance to a networked resource control platform; and
transmitting a resource alignment recommendation to the networked resource control platform in response to the prediction distance exceeding a predetermined threshold, wherein the resource alignment recommendation recommends revising a resource designation previously assigned to the enterprise resource.

15. The computer program product of claim 14, wherein the multipart machine learning model is constructed by combining a trained topic model, optimal transport, and word embeddings.

16. The computer program product of claim 15, wherein the multipart machine learning model is trained to discover one or more roles performed by the enterprise resource and a contribution that each role makes to an overall performance of the enterprise resource.

17. The computer program product of claim 16, wherein the multipart machine learning model measures a strength of association between the enterprise resource and multiple resource designations defined by the predetermined resource taxonomy, and wherein the strength of association is measured based on multiple prediction distances between roles performed by the enterprise resource and roles corresponding to the resource designations.

18. The computer program product of claim 17, wherein the operations further comprise:
generating a ranked listing of the multiple prediction distances for presentation in a graphical user interface (GUI) provided by the networked resource control platform;
wherein the GUI enables a user to hyperlink to descriptions associated with resource designations corresponding to each of the multiple prediction distances listed, the descriptions describing roles performed by a resource assigned to each of the resource designations.

19. The computer program product of claim 17, wherein the operations further comprise:
generating an image of a multi-dimensional vector space in which a vectorial representation of roles performed by the enterprise resource appears with one or more vectorial representations of roles defined by the predetermined resource taxonomy, wherein the image appears is capable of appearing in a graphical user interface provided by the networked resource control platform.

20. The computer program product of claim 14, wherein the operations further comprise:
performing the searching and generating the prediction distance in response to a predetermined triggering event.
